(19) United States
(12) Patent Application Publication
(10) Pub. No.: US 2008/0006643 A1
(43) Pub. Date: Jan. 10, 2008

(54) Insulated container

(76) Inventor: Gene Ma, Carlsbad, CA (US)

Correspondence Address: LAW OFFICES OF CLEMENT CHENG, 17220 NEWHOPE STREET #127, FOUNTAIN VALLEY, CA, 92708, US

(21) Appl. No.: 11/483,337

(22) Filed: Jul. 7, 2006

(51) Int. Cl. A47J 41/00

(52) U.S. Cl. 220/592.16

(57) ABSTRACT

A dual-purpose insulated container is disclosed. The container selectively holds a disposable cup such as a take-out coffee cup with a plastic lid containing a beverage or a beverage alone and it is in a double wall construction for insulation generally made of sturdy plastics and elastic materials that are snap coupled to each other in order to enable the consumer to carry the beverage heat protected in two optional modes with one container. Additionally, the container has a handle, which has a built-in plug on a strap. The plug acts to plug the hole that is present on the plastic caps of coffee cups dispensed by retail coffee chains. An auxiliary slide lid may be tightened directly to the container when there is only the beverage to hold. The container has a translucent insulation space that is normally closed but consumer accessible to insert or replace a printed sheet for a visual effect.

### BACKGROUND OF THE INVENTION

A. Field of the Invention

The present invention relates to a beverage container. More particularly, the present invention relates to an improved insulated container for holding beverages in a disposable cup alleviating the consumption of disposable sleeves.

B. Description of the Prior Art

Thermally retentive plastic mugs for coffee or the like are well known in the art. Consumers welcome their portability for carrying beverages at work or while driving. A typical retail coffee chain sells coffee in paper or foam cups with a plastic cap, that often provides little to no protection against heat transfer. As a solution, shorter paper sleeves are offered to help hold a hot cup, which are then discarded all together. However, simple layering of disposable materials could not provide an adequate insulation to enjoy the desirably hot or cold beverages leisurely and safely.

Some coffee aficionados avoid this problem by bringing their own insulated travel mug or tumbler to the retail stores to have the benefit of prolonged heat retention of their beverage purchase. In return, they still have the trouble of washing the mug, which could have been saved by simply discarding a disposable cup.

U.S. Pat. No. 6,367,652 discloses an insulated cup holder for plain paper cups, which can be refilled with a new paper cup having beverage in it. However, this cup holder is for holding a disposable cup only and cannot be converted to a spill-resistant mug for containing the beverage itself in case a paper cup fails or is not available or desirable. Thus, the cup holder would not be appropriate for a home brew beverage limiting its use with only take-out type cups.

The above and other available beverage vessels do not meet the needs for an advanced container, which is versatile as well as convenient. Therefore, it is desirable to have an insulated container for carrying either a coffee chain or home brew beverage at a desired temperature longer than a frail disposable cup can withstand. Also it is desirable to provide an aftereffect of eliminating the conventional paper sleeve waste.

In view of the foregoing, an object of the present invention is to provide an insulation beverage container that practically converge the above individual measures of consuming beverage including the diverse benefits of a simple handled mug, double-wall insulation, and paper cup disposability while excluding increased waste of paper sleeves.

Another object of the present invention is to provide a novel insulation beverage container for disposable cups with a built-in plug to prevent spilling, which is frequent with casual movements of disposable cups normally lacking a spill-prevention means.

Yet another object of the present invention is to provide a novel insulation beverage container for disposable cups with a visual function employing the insulation space in the container to express a custom graphic like a business logo that can be swiftly exchanged with a user's own photo or other expressions.

### SUMMARY OF THE INVENTION

The insulated container according to the present invention selectively holds a disposable cup such as a take-out coffee cup with a plastic lid containing a beverage or a beverage alone and it is made in a double wall construction for insulation generally made of sturdy plastics and elastic materials that are snap coupled to each other.

This has the effect of keeping the coffee warmer for longer durations of time, and is reusable, such that the paper cup and plastic cap in which the coffee is sold is inserted directly into this container or mug. When the consumer has completed the beverage, the paper cup and its plastic cap are removed from the mug and disposed, leaving the mug clean and ready to use for the next beverage.

An auxiliary lid or cap is provided with the mug in the event the consumer chooses to place coffee directly into the mug, much like a typical travel coffee mug is used. This allows the consumer to carry a beverage in two optional modes with one container.

Additionally, the mug has a handle, which has a built-in plug on a strap. The plug acts to plug the hole that is present on the plastic caps of coffee cups dispensed by retail coffee chains.

When the consumer is traveling, he or she may lift the plug off the plug port in the handle, and place it into the plastic cap so as to prevent any leakage or spills. The plug remains with the handle by virtue of a rubber leash, which doubles as a non-slip surface of the handle when the consumer drinks the coffee.

In one embodiment of the present invention, the insulated container comprises a cup-shaped inner liner for containing the beverage in the disposable cup partially closed or the beverage only, the inner liner having a flared open end extending outwardly and downwardly defining a downwardly facing annular clip and an auxiliary tubular mating area; an auxiliary slide closure having a dispensing spout and a tubular mating area for making connection with the auxiliary tubular mating area of the inner liner when the disposable cup is not present between the beverage and the inner liner; a clear cup-shaped shell enveloping the inner liner externally with a translucent space formed therebetween and releasably snapped into the annular clip of the inner liner, the shell having an outwardly and downwardly extending handle; and a spill plug with an elongated leash flexibly connected to the handle and movable between a rest position partially embedded in the handle and an active position to close the disposable cup completely.

The liner is evenly distanced from the shell to allow the translucent space to hold a printed sheet and an insulation gap.

The auxiliary tubular mating area of the liner is an inwardly threaded rim near the open end. The rim is displaced outwardly of a path through which the disposable cup enters the liner and the auxiliary slide closure may be a reusable disc-shaped lid including the spout, the tubular mating area threaded outwardly for mating with the inwardly threaded rim of the liner, a slot and a plug sealingly and slidably movable along the slot for opening and closing the spout of the lid.

Alternatively, the tubular mating areas between the liner and the lid may have multiple elastic rings to provide a frictional coupling for opening and closing the container.

The shell further comprising a number of teeth equidistantly formed along its top edge and the same number of alternate notches and the annular clip of the liner has the corresponding wall thickness to releasably clutch the tooth of the shell, whereby the liner may be separated manually from the shell for adjusting the axial position of the spout of the auxiliary slide closure relative to the handle before reengagement of shell and liner into a desired locked position.

The liner may be separated manually from the shell against its clipping force on the shell to permit a user access to the translucent space, whereby a printed sheet with a visual expression may be exchanged as desired. The bottom of the shell may have a mating protrusion and fitted with an elastic base having a corresponding interior profile to provide a non-slip bottom surface of the container. The elastic base may be an elastic layer applied to the shell bottom.

The insulated container further comprises a multiple sealing means formed between the liner and the auxiliary slide closure including a circumferential stepped surface at the junction of the rim to the liner facing inwardly and upwardly of the liner, an opposing lower edge of the slide closure abutting the stepped surface, an annular convex or concave area of the liner at its top face, an opposing area of the slide closure with correspondingly concave or convex shape, and/or an elastic ring tightened around the tubular mating area of the lid at its base. Embodiments of the invention will now be described by way of example with reference to the accompanying drawings.

### BRIEF DESCRIPTION OF THE DRAWINGS

FIG. 1 is an exploded perspective view of an insulated container according to the present invention shown with an application of a common disposable cup.

FIG. 2 is a perspective view of the insulated container of FIG. 1 in operation.

FIG. 3 is a cross sectional view of the insulated container in operation taken along line 3-3 of FIG. 2.

FIG. 4 is an exploded perspective view of the insulated container of FIG. 1 shown with an optional spill-proof slide lid to carry the beverage insulated when the disposable cup is not available or desirable.

FIG. 5 is a cross sectional view of the insulated container in operation taken along line 5-5 of FIG. 4.

Similar reference numbers denote corresponding features throughout the attached drawings.

### DETAILED DESCRIPTION OF THE PREFERRED EMBODIMENT

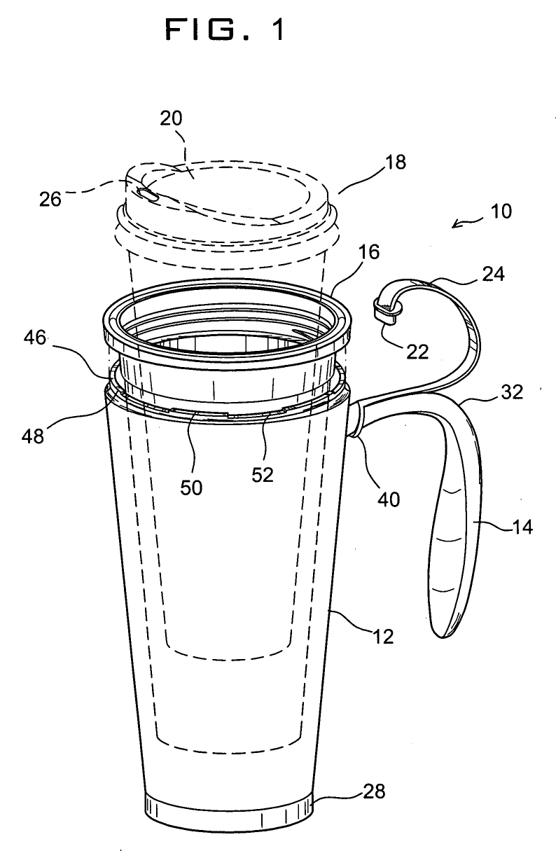

With reference to FIG. 1, an insulated container or mug 10 according to the present invention generally comprises a clear cup shell 12 with a handle 14 and an opaque inner liner 16 adapted to receive and support a common disposable cup 18 about its sidewalls. Conforming the sidewalls of the standard disposable cup, the cup shell 12 and liner 16 have a common downward taper. The cup 18 has a disposable plastic lid 20 that is press fit onto its upper end. Similar to the disposable cup 18 and lid 20, components of the inventive container 10 are fastened together via snap-in methods.

The cup shell 12 may be made of a clear plastic such as a polycarbonate while the liner 16 may be one of various opaque plastics. Preferably, the mug would be made of a certain percentage of recycled plastic to enhance the environmental friendliness of the product. Also, the plastic should be microwave and dishwasher safe.

Built onto the handle 14 is an elastic spill plug 22 with an integral leash 24 that connects the plug 22 close to a proximal end of the handle 14. The elastic leash 24 is shown here at a transition state from a rest position along an outward face of the handle 14 to a deployed position to allow the plug 22 inserted in an outlet 26 of the lid 20 after the cup 18 is received in the container 10.

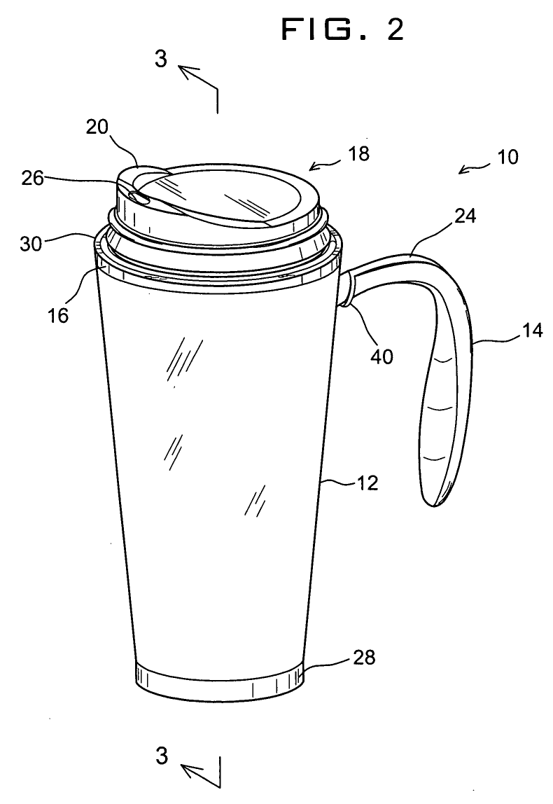

To the bottom of the cup shell 12 is affixed a non-slip elastic base 28 or a frictional layer may be deposited thereto for securely positioning the container 10 even on a slippery surface. FIG. 2 shows the container 10 holding the disposable cup 18 that is assumed to contain hot coffee and has its lid 20 held close to a top edge 30 of the liner 16. To prevent the lid 20 from being forced out involuntarily, the inner diameter of the liner 16 is limited to stop the standard disposable cup 18 from dropping below the top edge 30 of the liner 16. In this way, an advantageous clearance is maintained between the cup 18 and the container 10 to permit an easy separation at the time of cup 10 disposal. The inside diameter is preferably 3.3″ or 84 mm. The outside diameter is preferably 3.45″ or 87 mm. The diameter at the bottom of the mug is approximately 2.5″. The disposable cup is preferably about 6.5″ in height and has an outside diameter of 84 mm at the top and 64 mm at the bottom.

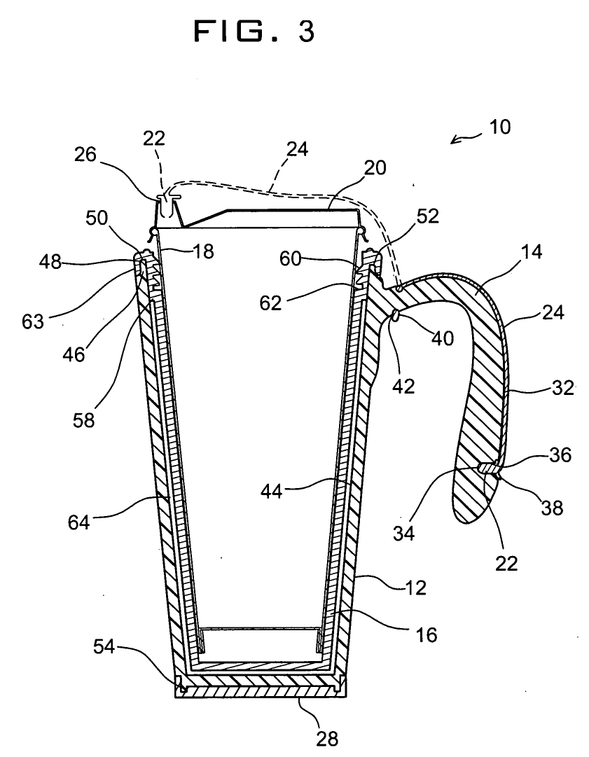

The elastic leash 24 is shown in its rest position providing an effective grip surface for a user's thumb and other parts of the hand. The structures of container parts and their positional relations are detailed in FIG. 3 wherein the elastic leash 24 is seated in a long recess 32 formed in the outward face of the handle 14 so that approximately half of the thickness of the leash 24 sinks under the surface of the handle 14 leaving the outer half exposed to the touch of the hands. The width of the leash 24 may be set so that it extends partially the area of the outward surface of the handle 14.

The spill plug 22 has a rounded tip 34, which may be pushed into the outlet 26 of the lid 20 or a plug port 36 formed in the handle 14 at its distal area. The plug 22 also has a peripheral flange 38 for limiting the depth of insertion of the plug 22 into the handle 14 or the outlet 26 of the lid 20. The flange 38 doubles as a pull-tab for a finger to pull out the plug 22 from the port 36.

At its proximal end opposite to the plug 22, the plug leash 24 is terminated by a ring 40, which may be seated in an annular groove 42 formed in the handle 14 near its proximal end at an oblique angle to the perpendicular direction to the extension of the handle 14 to prevent weakening of the handle 14 against possible deflections of the handle 14 about its junction with the cup shell 12.

Though the handle 14 in the illustrated embodiment is integrally formed with the cup shell 12, it is contemplated that differing materials of handle may be prepared with an oversized sleeve, which may be pressed over the cup shell having smooth round sidewalls.

Referring to FIGS. 1 and 3 together, snap-in assemblies of the cup shell 12, liner 16 and rubber base 28 will be described.

The shell 12 has a round interior of sidewalls 44 with downward tapers closed at a flat bottom but formed with an annular lip 46 at an open top extending upwardly and outwardly. The lip 46 is formed from an L-shaped cut out around the upper outer edge of the shell 12 so that it has a chamfered end 48, which overhangs relative to its base at the junction with the body of the shell 12 just below. In addition, a number of teeth 50 are equidistantly formed on the lip 46. Notches 52 in between define the teeth 50, which will releasably clutch the corresponding areas of the opposing liner 16 to prevent the liner 16 from rotating against an axial force relative to the shell 12.

At the bottom end, a protruding rib 54 is formed on the outer surface of the shell 12 as shown in FIG. 3. And a corresponding interior profile of the rubber base 28 is pressed onto the bottom of the shell 12. Alternatively, a thin rubber layer may be deposited by spraying or otherwise applied to the shell bottom.

The liner 16 is generally cup shaped to hug the disposable cup 18 at a slightly elevated level except its flared top portion, which includes an outwardly expanded rim 58 having an inner thread 60 for fastening an optional sliding lid for allowing the container to be used in containing a beverage by itself without a disposable cup as will be described below. The thread 60 is displaced outwardly of the extension line of the interior walls of the liner 16. At the junction of the rim 58 to the liner 16 there is formed a step 62 that protrudes slightly inwardly of the apexes of the thread 60. The opposite end of the rim 58 is folded back to form an annular clip 63 with downward tapers that is adapted to be press fitted over the chamfered end 48 of the outer shell 12. Therefore, an insulating space 64 is formed between the shell 12 and liner 16 under the rim 58 and throughout the bottom area of the container 10.

The overhang of the shell end 48 and the downward tapers of the rim clip 63 secure a tight interconnection between the shell 12 and liner 16 while yielding to an intentional manual separation of the two when necessary.

It is important that the assembly and disassembly of the shell 12 and liner 16 can be done at user's hands. Slightly pulling the liner 16 away from the shell 12 will release their assemblage to allow an access to the insulation space 64 therebetween. Taking advantage of the access as well as the translucency or transparency of the shell 12, a user can place a visually pleasing graphic sheet or a choice of photo before reassembling the two components without interfering the insulating performance. This allows personalization of the individual container that a user loves to take along a statement of the owner's lifestyle and interests. The retail stores or distributors of the container 10 may initially use their own graphics in the container 10 as a marketing tool that may be swiftly replaced by the consumer's creations.

For this purpose, the distance between the opposing surfaces of the shell 12 and liner 16 is preferably 0.075″.

The spill plug 22 with elastic leash 24 is in its rest position in FIG. 3 where the position in action is also shown in dotted lines. With the plug 22 closing the outlet 26 the disposable cup 18 now becomes a safer cup to transport without concern of spilling the hot beverage content as well as contaminating the surrounding.

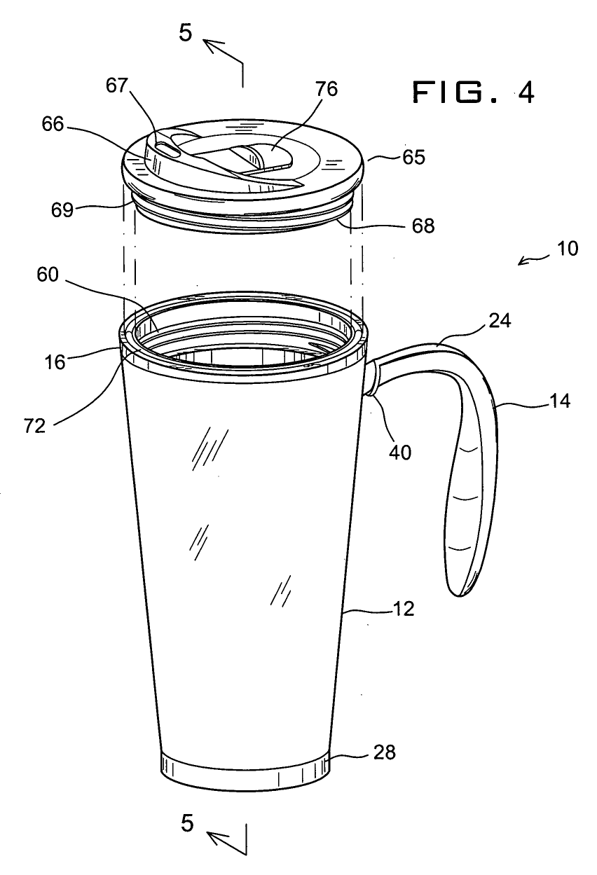

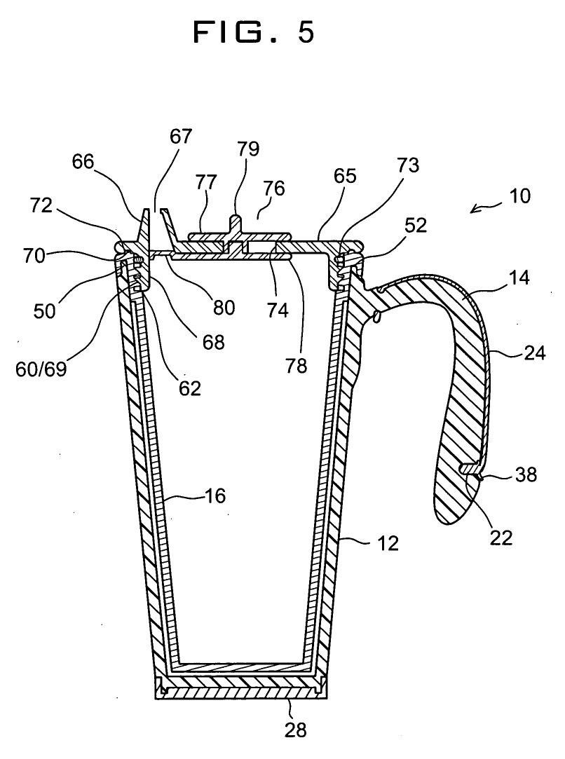

FIGS. 4 and 5 show an optional disc-shaped lid 65 having an arch-shaped spout 66 partially opened at an outlet 67 and a perpendicular tubular section 68 with an outer thread 69 for an engagement with the thread 60 of the liner 16. The lid 65 may be made of a similar heat resistant plastic material used to make the liner 12.

When threaded, the tubular section 68 of the lid 65 abuts the step 62 of the liner 16 to provide a primary sealing contact. Externally of the tubular section 68 the lid 65 also has an annular concave area 70 facing downwardly. Then, a corresponding annular convex area 72 formed on the top surface of the liner 16 mates with the lid 65 at the concave area 70 providing a secondary sealing contact against any possible leakage of beverage between the threads 60 and 69. The convex and concave areas may switch places between the liner 16 and the lid 65. In addition, a rubber or silicone ring 73 running tightly about the outer surfaces of the tubular section 68 near its junction to the lid body may further seal the container 10.

The mating threads of the liner 16 and the lid 65 may be replaced by a frictional coupling through multiple elastic rings installed on the opposing tubular sections of the liner 16 and the lid 65 to provide a simpler opening or closing of the container.

The optional lid 65 also has a slot 74 in the center and a sliding plug 76. The plug 76 consists of an upper member 77 and a lower member 78 snap fitted together through the central slot 74 so that the plug 76 can be sealingly pushed or pulled toward and away from the outlet 67 along a path parallel to the lid 65. For an easy sliding push or pull the upper plug member 77 has a knob 79 in the center. A plug portion 80 extending from the lower plug member 78 into the spout 66 can close a fluid communication through the outlet 67.

The lid preferably has a rubber grommets mounted against the outside surface of an inserted portion that fits into the container biasing the rubber grommets against the inside surface of the container. The inside diameter of the lid is preferably 3.3″ and the outside diameter of the lid is preferably 3.45″.

Ventilation holes not shown may be formed on the lid body 65 and the sliding plug 76 so that when the knob 79 is in its open position the holes communicate to vent excessively hot steam in the container 10 as is well known in the art.

The axial position of the spout 66 may be adjusted relative to handle 14. With the lid 65 tightened to the liner 16 one can pull them off the cup shell 12 by grasping the container 10 at the handle 14 with one hand and at the liner 16 or lid 65 with another hand disengaging the teeth 50 and notches 52 to reposition spout 66 relative to the handle 14. Then, the liner/lid assembly may be turned against the shell 12 and pushed back into an appropriate locked position on the shell 12. Once this position is set, subsequent opening or closing the lid 65 may always initiate and stop at the same axial position best suited to the user's preference, which may change. The liner/lid assembly is preferably a black color.

With the lid 65 on, the container 10 is fully functional to carry out a home beverage by itself. But after removing the lid 65 with some washing the container 10 is refreshed as a disposable-cup sleeve complete with the built-in spill plug 22 as described above.

Therefore, while the presently preferred form of the insulated container for disposable coffee cups or beverages has been shown and described, and several modifications thereof discussed, persons skilled in this art will readily appreciate that various additional changes and modifications may be made without departing from the spirit of the invention, as defined and differentiated by the following claims.

1. An insulated container for a disposable cups comprising:
a disposable cup;
a cup-shaped inner liner for selectively containing the beverage in the disposable cup partially closed or the beverage only, the inner liner having a flared open end extending outwardly and downwardly defining a downwardly facing annular clip and an auxiliary tubular mating area;
an auxiliary slide closure having a dispensing spout and a tubular mating area for making connection with the auxiliary tubular mating area of the inner liner when the disposable cup is not present between the beverage and the inner liner;
a clear cup-shaped shell enveloping the inner liner externally with a translucent space formed between and releasably snapped into the annular clip of the inner liner, the shell having an outwardly and downwardly extending handle; and
a spill plug with an elongated leash flexibly connected to the handle and movable between a rest position partially embedded in the handle and an active position to close the disposable cup completely.

2. The insulated container of claim 1, wherein the liner is distanced from the shell by about 0.075 inches to have the translucent space hold a printed sheet and insulation air.

3. The insulated container of claim 1, wherein the auxiliary tubular mating area of the liner is an inwardly threaded rim near the open end, the rim being displaced outwardly of a path through which the disposable cup enters the liner and the auxiliary slide closure is a reusable disc-shaped lid including the spout, the tubular mating area threaded outwardly for mating with the inwardly threaded rim of the liner, a slot and a plug sealingly and slidably movable along the slot for opening and closing the spout of the lid.

4. The insulated container of claim 1, wherein the tubular mating areas between the liner and the lid have multiple elastic rings to provide a frictional coupling for opening and closing the container.

5. The insulated container of claim 1, wherein the shell further comprising a number of teeth equidistantly formed along its top edge and the same number of alternate notches and the annular clip of the liner has the corresponding wall thickness to releasably clutch the tooth of the shell, whereby the liner is releasably detachable and reattachable to the shell for adjusting the axial position of the spout of the auxiliary slide closure relative to the handle before reengagement of shell and liner into a desired locked position.

6. The insulated container of claim 5, wherein the liner may be separated manually from the shell against its clipping force on the shell to permit a user access to the translucent space, whereby a printed sheet with a visual expression may be exchanged as desired.

7. The insulated container of claim 1, wherein the shell further comprising a bottom section protruding downwardly and an elastic base with a corresponding interior profile that is press fitted onto the bottom of the shell to provide a non-slip bottom surface of the container.

8. The insulated container of claim 1, wherein the shell further comprising a bottom section covered by an elastic layer to provide a non-slip bottom surface of the container.

9. The insulated container of claim 1, further comprising a multiple sealing means formed between the liner and the auxiliary slide closure including a circumferential stepped surface at the junction of the rim to the liner facing inwardly and upwardly of the liner, an opposing lower edge of the slide closure abutting the stepped surface, an annular convex or concave area of the liner at its top face, an opposing area of the slide closure with correspondingly concave or convex shape, and/or an elastic ring tightened around the tubular mating area of the lid at its base.

10. An insulated container for a paper cup comprising:
a cup-shaped inner liner, the cup-shaped inner liner having a larger circular open end and a circular base that is smaller than the open end;
a clear shell enveloping the inner liner to form a translucent space between the clear shell and inner liner.

11. The insulated container of claim 10, further comprising a spill plug with an elongated leash flexibly connected to the handle and movable between a rest position partially embedded in the handle and an active position to close the disposable cup.

12. The insulated container of claim 11, further comprising a lid.

13. The insulated container of claim 11, further comprising a paper cup held within the cup-shaped inner liner.

14. The insulated container of claim 13, wherein the paper cup is about 6.5″ in height and has an outside diameter of 84 mm at the top and 64 mm at the bottom.

15. The insulated container of claim 10, further comprising a printed graphic sheet mounted in the translucent space.

16. The insulated container of claim 15, wherein the paper cup is about 6.5″ in height and has an outside diameter of 84 mm at the top and 64 mm at the bottom.

17. An insulated container for disposable cups or beverages comprising:
a cup-shaped inner liner, the inner liner having a flared open end extending outwardly and downwardly defining a downwardly facing annular clip and an auxiliary tubular mating area;
a clear shell enveloping the inner liner to form a translucent space between the clear shell and inner liner;
a printed graphic sheet mounted in the translucent space, wherein the printed graphic sheet is visible by a user; and
a paper cup fit into the cup-shaped inner liner.

18. The insulated container of claim 17, further comprising a lid paper cup fitted over the opening of the paper cup.

19. The insulated container of claim 18, wherein the paper cup is about 6.5″ in height and has an outside diameter of 84 mm at the top and 64 mm at the bottom.

20. The insulated container of claim 17, further comprising a lid having a sliding opening.
